(19) United States
(12) Patent Application Publication
(10) Pub. No.: US 2003/0183343 A1
(43) Pub. Date: Oct. 2, 2003

(54) Hand labeler for liner-free label tape

(76) Inventor: Toshikazu Kawada, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/401,777

(22) Filed: Mar. 31, 2003

(30) Foreign Application Priority Data
Apr. 1, 2002 (JP) 2002-98530

(51) Int. Cl. B32B 31/00

(52) U.S. Cl. 156/510; 156/577

(57) ABSTRACT

In order to use a length of tape having no liner on its rear side, a hand labeler includes a tape-feeding mechanism having a rotary drum for making the length of tape advance a predetermined length; and a tape peeling-off mechanism for forcedly unrolling the tape roll against its adhesive power. The peeling-off mechanism is placed between the tape holder section and the rotary drum of the tape-feeding mechanism, and it comprises a peeling-off drum ganged with the rotary drum of the tape-feeding mechanism and a tape-feeding roll or rolls freely rotatable to cooperate with the circumference of the peeling-off drum for gripping the length of tape.

### BACKGROUND OF THE INVENTION

1. Field of the Invention

The present invention relates a hand labeler for cutting a liner-free tape and applying separate labels to goods.

2. Related Art

A conventional hand labeler uses a label tape lined with a release liner. In use every time the label tape has been fed a predetermined length, labels are peeled off from the release liner one after another to be applied to goods, as shown in JP 61-11509U.

The release liner is thrown away after labeling. From the economical and resource saving points of view there was a demand for saving a relatively large quantity of release liner, which is finally taken out as rubbish.

To meet such demand the applicant filed a patent application, titled “Liner-Free Label Tape Cutter-and-Applicator” (JP 2001-315731A corresponding to U.S. application Ser. No. 09/644,814).

One object of the present invention is to provide an improved hand labeler enabling a length of liner-free label tape to be fed smoothly against its adhesive power.

### SUMMARY OF THE INVENTION

To attain this object a hand labeler comprising: a seal printing mechanism operatively connected to a handle of the labeler for printing a length of tape via a link mechanism, which can be put in operation by squeezing the handle of the labeler; a tape-feeding mechanism having a rotary drum for making the length of tape advance a predetermined length; and a cutting mechanism responsive to the return of the handle to its release position for cutting the length of tape, is improved according to the present invention in that it further comprises a tape peeling-off mechanism for forcedly feeding the length of tape against its adhesive power, which mechanism is placed between the tape holder section and the rotary drum of the tape-feeding mechanism, and comprises a peeling-off drum ganged with the rotary drum and a tape-feeding roll or rolls freely rotatable to cooperate with the circumference of the peeling-off drum for gripping the length of tape.

The hand labeler further comprises a ratchet mechanism comprising a ratchet toothed-wheel and associated ratchet nailed wheel for allowing the peeling-off drum to rotate a predetermined angle intermittently, thereby feeding the length of tape step by step.

The length of tape has no liner on its rear side, which the rear side is coated with adhesive.

With above described arrangement a continuous length of label tape can be smoothly fed out from a tape roll, and is printed and cut so that separate labels may be applied to goods one after another.

Other objects and advantages of the present invention will be understood from the following description of a hand labeler for liner-free label tape according to one embodiment of the present invention, which is shown in accompanying drawings.

### BRIEF DESCRIPTION OF THE DRAWING

FIG. 1 is a perspective view of a hand labeler for liner-free label tape according to the present invention;

FIG. 2 is a side view of the hand labeler of FIG. 1;

FIG. 3 is an exploded view of a fragment of the hand labeler, illustrating how a second inkpad is fitted in an associated mount;

FIGS. 4a and 4b show how a second printing head is fitted in an associated mount;

FIG. 5 is a perspective view of a tape feeding mechanism and tape peeling-off mechanism;

FIG. 6 is an exploded view of the tape feeding mechanism and tape peeling-off mechanism;

FIG. 7 is an exploded view of a cutting mechanism;

FIGS. 8a and 8b illustrate how the cutting mechanism works;

FIG. 9 is an exploded view of the hand labeler;

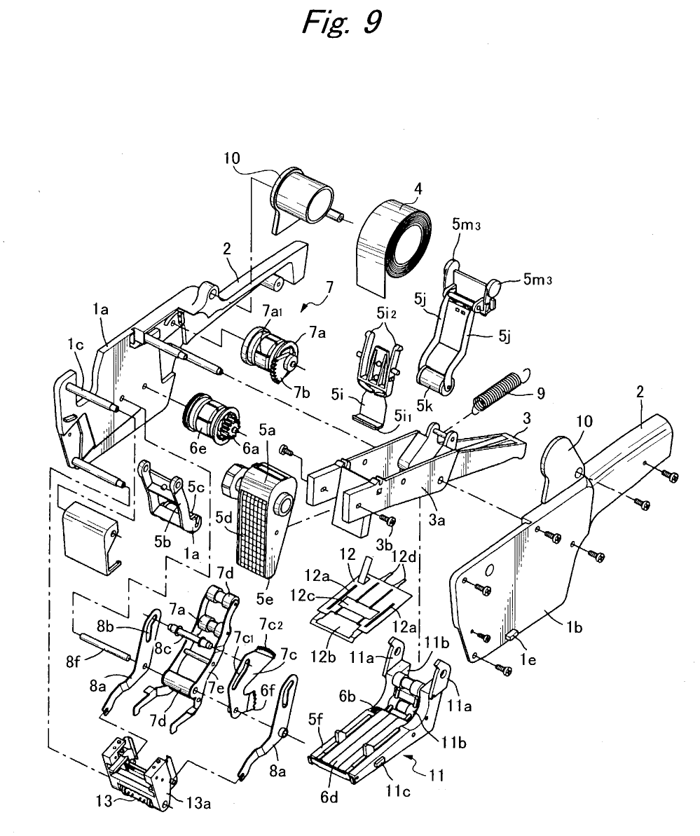

FIG. 10 illustrates how a continuous length of label tape is mounted in the hand labeler (its bottom lid being opened);

FIG. 11 illustrates how the hand labeler is immediately after the first and second inkpads touch and move away from the associated printing heads;

FIG. 12 illustrates how the peeling-off mechanism forcedly feeds the continuous length of label tape against its adhesive power;

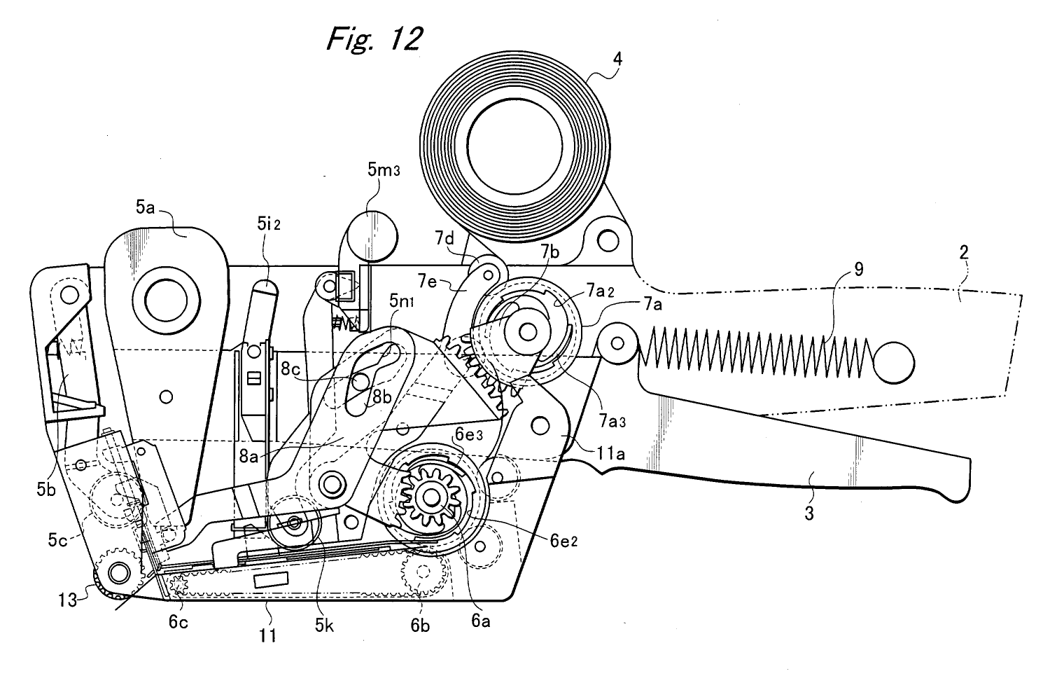

FIG. 13 illustrates how the hand labeler prints the label tape with the wet printing heads; and

FIG. 14 illustrates how the hand labeler is after being taken out the printed label by the geared belt.

### DETAILED DESCRIPTION OF PREFERRED EMBODIMENT

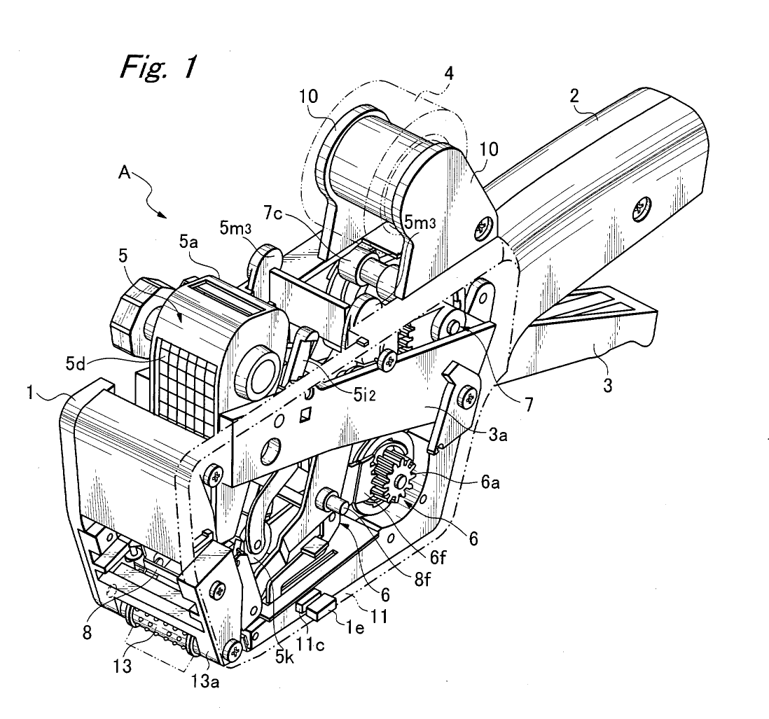

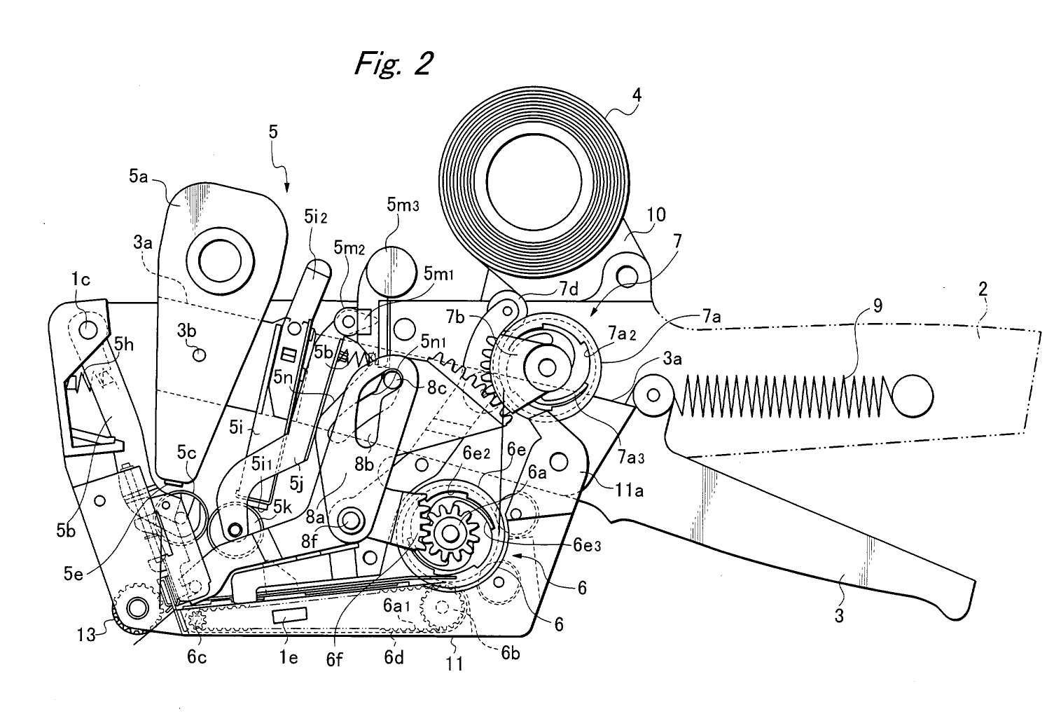

Referring to FIGS. 1 and 2, a hand labeler A according to one embodiment of the present invention comprises a labeler body 1 having a stationary grip 2 and a movable lever or handle 3, a seal printing mechanism 5 operatively connected to the handle 3 for printing a length of tape 4 via a link mechanism, which can be put in operation by squeezing the movable handle 3 toward the stationary grip 2; a tape-feeding mechanism 6 having a rotary drum 6e for making the length of tape 4 advance a predetermined length; and a tape peeling-off mechanism 7 for forcedly peeling off the length of tape 4 from the tape roll against its adhesive power, and a cutting mechanism 8 responsive to the return of the movable handle 3 to its release or stress-free position for cutting the length of tape 4.

The handle 2 is normally spring-biased toward its opening or stress-free position by a pulling spring 9.

The length of label tape 4 has no liner on its rear side, which rear side is coated with adhesive. The label tape roll is rotatably held in a roll holder section 10.

The seal printing mechanism 5 comprises a first printer unit 5a bolted by a screw 3b to the free end of a rotary arm 3a integrally connected to and extending from the movable handle 3, and a first swingable inkpad supporter 5b having a first inkpad 5c rotatably held at its free end. The first swingable inkpad supporter 5b is responsive to movement of the first printer unit 5a for swinging and bringing the first inkpad 5c close to and apart from the printing head 5e of the first printer unit 5a.

The first printer unit 5a is an ordinary rotary printer unit, which has print-faced endless belts 5d wound around its rotary disks, and the first print head 5e is responsive to the swinging movement of the handle extension 3a for rising apart and descending close to an underlying geared endless belt 6d.

The first inkpad support frame 5b is rotatably fixed to the opposite side plates 1a and 1b of the labeler body 1 on its forward side by using a cross axle 1c, and the first inkpad 5c is pivoted to the lower end of the inkpad support frame 5b. The first inkpad 5c can be rotated relative to the inkpad support frame 5b, and can be removed therefrom to be changed for a new one.

As seen from FIG. 2, the first inkpad support frame 5b is normally spring-biased inward by a spring member 5h, which may be a coiled spring or plate spring. Thus, the first inkpad 5c is normally put in its inward position.

With this arrangement the first printing head 5e is forcedly applied to the first inkpad 5c by squeezing the movable handle 3 a little, and then the movable handle 3 is squeezed still further, allowing the first inkpad support frame 5b to swing outward, making way for the descending printing head 5e. After printing, the first inkpad support frame 5b automatically returns to its initial position under the influence of the spring member 5h.

The seal printing mechanism 5 further comprises a second printer unit 5i detachably arranged in the vicinity of the first printer 5, a second swingable inkpad supporter 5j responsive to movement of the movable handle 3, and a second inkpad 5k rotatably fixed to the free end of the second inkpad support frame 5j.

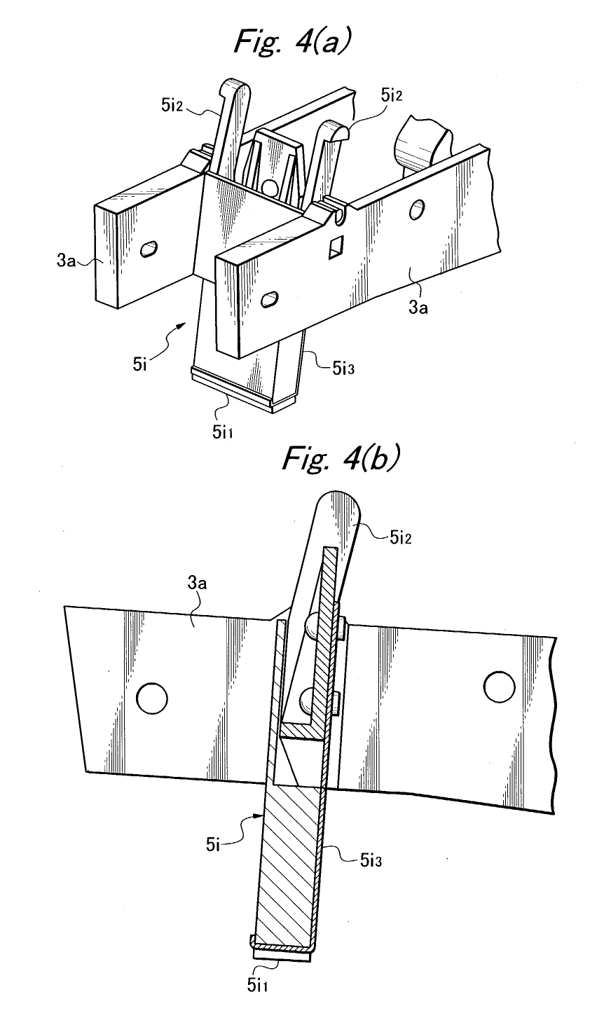

The second printer unit 5i functions to print some letters representing additional pieces of information such as “ON SALE”. As seen from FIG. 4, it comprises an insertion unit 5i₃ having thumb grip extensions 5i₂ and a second printing head 5i₁, and is detachably inserted in the bifurcate end of the rotary arm 3a of the movable handle 3. When it is desired that additional letters be changed, the insertion unit 5i₃ is removed and changed for another insertion unit simply by pinching and pulling up the thumb catch extensions 5i₂.

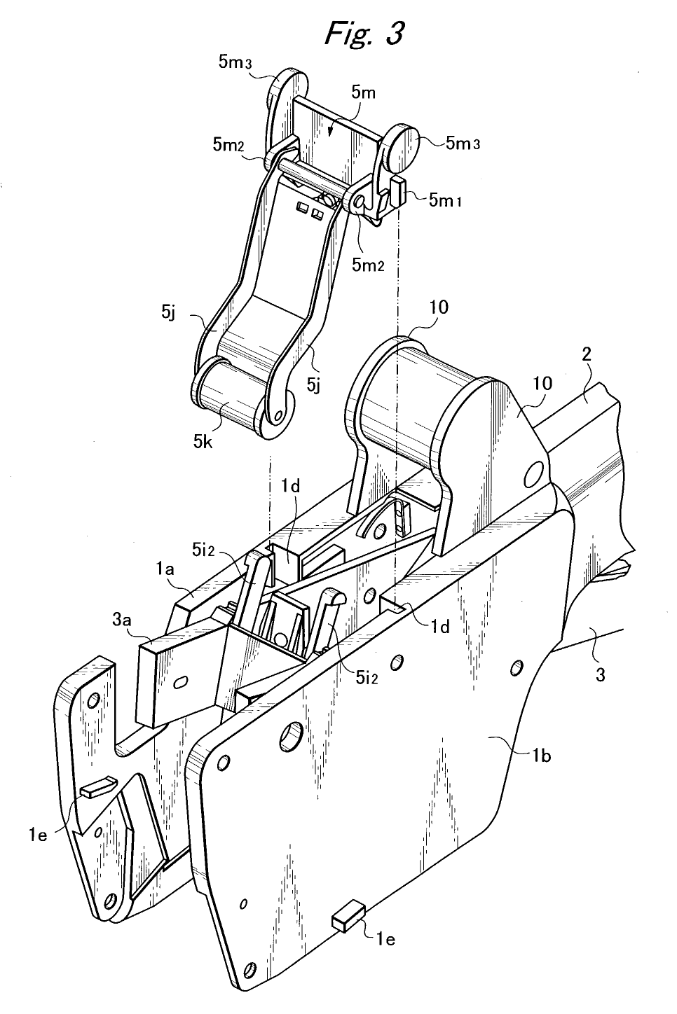

As seen from FIG. 3, the second swingable inkpad supporter 5j has an inkpad 5k rotatably fixed to its free end. The second swingable inkpad supporter 5j is swingable relative to an associated stationary mount 5m, which comprises an upright plate having vertical projections 5m₁, horizontal projections 5m₂ and upper, round thumb catches 5m₃ all formed on its opposite sides. The second swingable inkpad supporter 5j is pivoted to the horizontal projections 5m₂. The stationary mount-and-swingable frame assembly can be detachably inserted between the opposite side plates 1a and 1b of the labeler body 1 by pushing the opposite projections 5m₁ in the slots 1d, which are made in the side plates 1a and 1b.

In order to make the second swingable inkpad supporter 5j responsive to movement of the movable handle 3 for attaining its function, it is so positioned that its posture may be determined by the convex part 5n of a movable curved plate 7c, and a spring member 5o to spring-bias the inkpad supporter 5j forward (see FIG. 2).

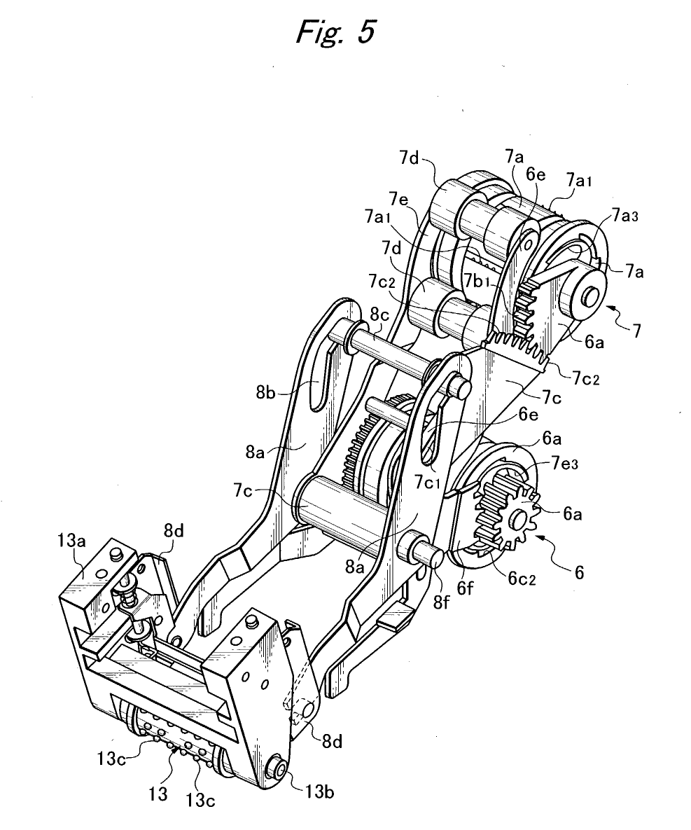

The movable curved plate 7c has two toothed arc-sections 6f and 7c₂ formed at its opposite ends, and a curved cam slot 7c₁ made close to its convex side. Two ganging links 8a each having a curved cam slot 8b made in its upper part are pivoted to the opposite side plates 1a and 1b of the labeler body 1 by its pivot shaft 8f (see FIG. 5), and these ganging links 8a have a cam axle 8c inserted in their cam slots 8b. Also, the cam axle 8c is inserted in the cam slot 7c₁ of the movable curved plate 7c.

When the movable handle 3 is squeezed, the drive gear 6a turns counterclockwise to incline the movable curved plate 7c clockwise, making the second inkpad supporter 5j change in position while the inkpad 5k rolls on the second print head 5i₁ of the second printer unit 5i. Then, the inkpad 5k makes the way for the descending second print head 5i₁ for printing the length of tape 4.

The tape-feeding mechanism 6 uses a one-way ratchet mechanism as described later. It includes a main drive gear 6a, a wheel gear 6b ganged with the drive gear 6a, a pinion gear 6c placed in the vicinity of a cutter 8e (later described), and a geared endless belt 6d winding around the pinion gear 6c and the wheel gear 6b (see FIG. 2).

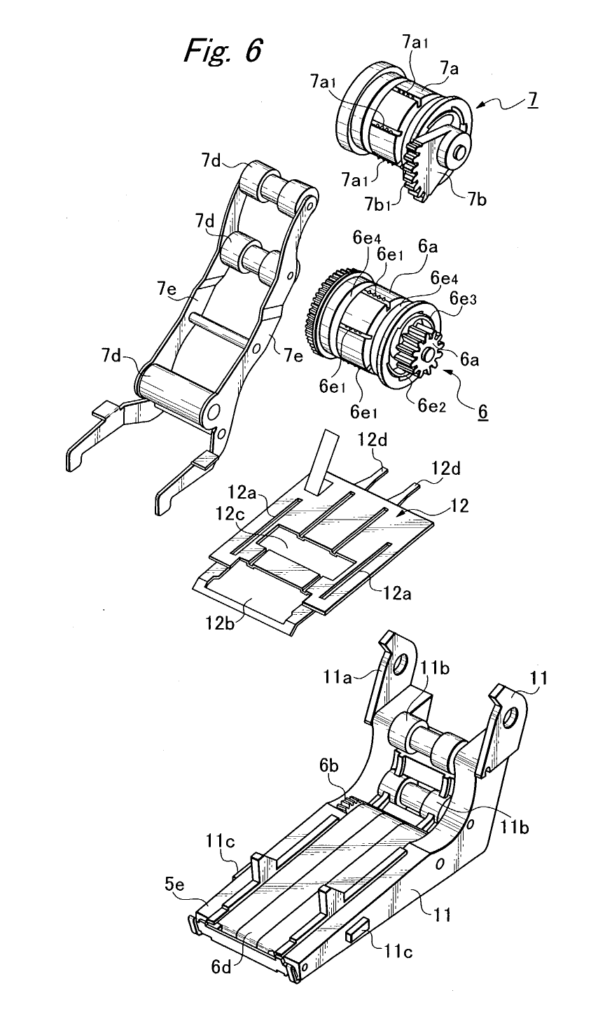

Referring to FIGS. 5 and 6, the drive gear 6a is concentrically fixed to a rotary drum 6e, which has belt feeding teeth 6e₁ formed on its circumference, and a ratchet toothed wheel 6e₂ fixed to the rotary drum 6e and a ratchet nailed wheel 6e₃ fixed to the drive gear 6a. The ratchet nailed wheel 6e₃ turns in the same direction as the drive gear 6a. The ratchet nailed wheel 6e₃ can be caught by a selected detent tooth of the ratchet toothed wheel 6e₂ when rotating a predetermined angle in one direction, but cannot be caught when rotating in the other direction.

When the movable handle 3 is squeezed (or closed), the drive gear 6a and hence the ratchet nailed wheel 6e₃ turns in one direction (counterclockwise direction), not being caught by any ratchet detent tooth of the ratchet toothed wheel 6e₂. When the movable handle 3 is released (or opened), the drive gear 6a and hence, the ratchet nailed wheel 6e₃ turns in the clockwise direction (clockwise direction), thus allowing the ratchet nailed wheel to be caught by a selected ratchet detent 6e₂. Thus, the rotary drum 6e is made to turn, so that the length of tape 4 may advance.

The geared endless belt 6d has slots 6d₁ made on its inner surface, winding around the pinion gear 6c and the wheel gear 6b, which is integrally connected to the bottom lid 11.

The tape peeling-off mechanism 7 cooperates with the tape-feeding mechanism 6 to forcedly peel off the length of tape 4 from the tape roll against its adhesive power. Referring to FIGS. 5 and 6, it includes a peeling-off drum 7a for feeding the unrolled length of tape forward.

As is the case with the rotary drum 6e, the peeling-off drum 7a has tape feeding teeth 7a₁ formed on its circumference and a ratchet toothed-wheel fixed to one end, and the peeling-off drum 7a can freely rotate about its axle 7. A ratchet nailed wheel 7a₃ and an arc-toothed sector 7b are fixed to the axle 7 of the rotary drum 7a. The peeling-off drum 7a is ganged with the ganging links 8a via the ratchet toothed- and nailed-wheels (or ratchet mechanism), the arc-toothed sector 7b, the movable curved plate 7c and the cam axle 8c. Referring to FIG. 6, a tape-feeding ladder has a series of rolls 7d pivoted to its opposite oblique frames 7e, and the tape-feeding ladder is arranged adjacent to the peeling-off drum 7a, allowing the length of tape 4 peeled-off from the tape roll to come down to the cutter mechanism 8 on the downstream side of the running tape.

In operation, when the movable handle 3 is squeezed (or closed), the drive gear 6 rotates counterclockwise to make the movable curved plate 7c turn clockwise, and hence, the arc-toothed sector 7b turns counterclockwise. Thus, the ratchet nailed wheel 7a₃ turns a predetermined angle to be caught by a selected detent tooth of the ratchet toothed-wheel of the peeling-off drum 7a. Accordingly the peeling-off drum 7a turns the predetermined angle to pull out a length of tape corresponding to the predetermined angle from the tape roll against its adhesive power.

When the movable handle 3 is released (or opened), the drive gear 6 rotates clockwise to make the movable curved plate 7c turn counterclockwise, and hence, the arc-toothed sector 7b turns clockwise. Thus, the ratchet nailed wheel 7a₃ turns clockwise without being caught by the ratchet toothed-wheel of the peeling-off drum 7a. Thus, the peeling-off drum 7a remains still, not pulling out the tape 4 from the tape roll.

Referring to FIGS. 5, 7 and 8, the cutting mechanism comprises the ganging links 8a, the cam axle 8c inserted in the cam slots 8b of the ganging links 8a, and the cutter 8e attached to the lower ends of the ganging links 8a via an associated holder 8d. It should be noted that the cam slot 8b is so shaped that the tape cutting may be synchronized with the tape feeding.

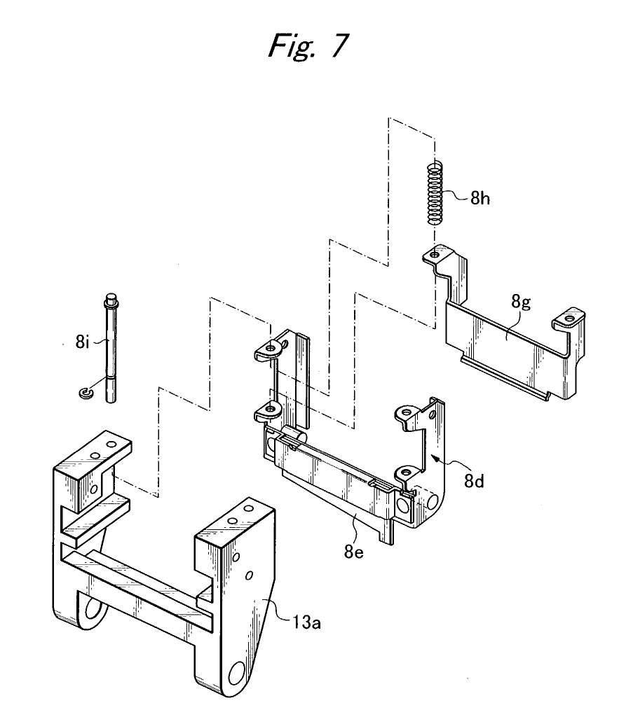

Referring FIG. 7, the cutter blade 8e is fixed to a “U”-shaped frame 8d, which has a cover piece 8g arranged behind. The cover piece 8g is attached to the “U”-shaped holder 8d by using coiled springs 8h and rods 8i so that the cover piece 8g may rise and descend resiliently. The cutter assembly is nested with a roll press holder frame 13a.

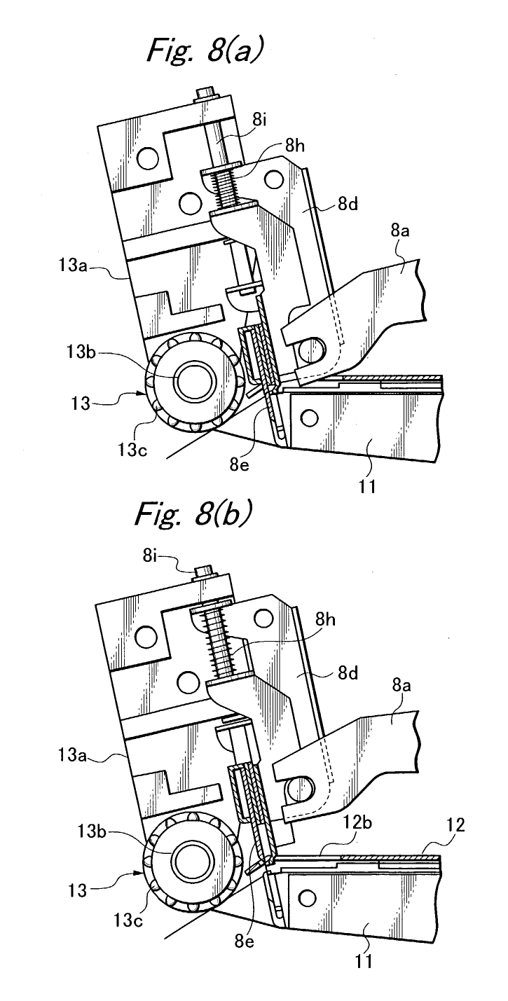

The cutting mechanism is attached to the bifurcate ends of the opposite ganging links 8a via the “U”-shaped frame 8d. When the ganging links 8a turns about its pivot 8f to incline forward, the cutter blade 8e is pushed down to cut the continuous tape 4 (see FIG. 8).

The bottom lid 11 is hinged to the bottom of the labeler body 1. Specifically the bottom lid 11 has tape feeding rolls 11b rotatably fixed to its opposite sides, and the wheel gear 6b and the pinion gear 6c are combined with the bottom lid 11 (see FIG. 2).

The bottom lid 11 has depressible lock projections 11c on its opposite sides. The bottom lid 11 can be fastened to the labeler body 1 by depressing the lock pieces 11c, and by releasing them into the counter holes of the opposite side plates 1a and 1b. The bottom lid 11 can be unlocked by depressing the depressible lock pieces 11c, so that it may be opened by its gravity.

A tape guide plate 12 is laid above the geared endless belt 6d. In the tape guide plate 12 two longitudinal ridges 12a are formed on its upper surface; two rectangular openings 12b and 12c are made to permit the first and second printing heads 5e and 5i₁ to pass therethrough for printing; and two rear projections 12d to be inserted in the circumferential grooves 6e₄ of the rotary drum 6e.

Referring to FIG. 8, a pressure roll 13 is pivoted to a roll holder 13a to turn about its axle 13b. The pressure roll 13 has small flexible protrusions 13c formed on its circumference, functioning to apply a separate piece of tape 4 to objects for labeling.

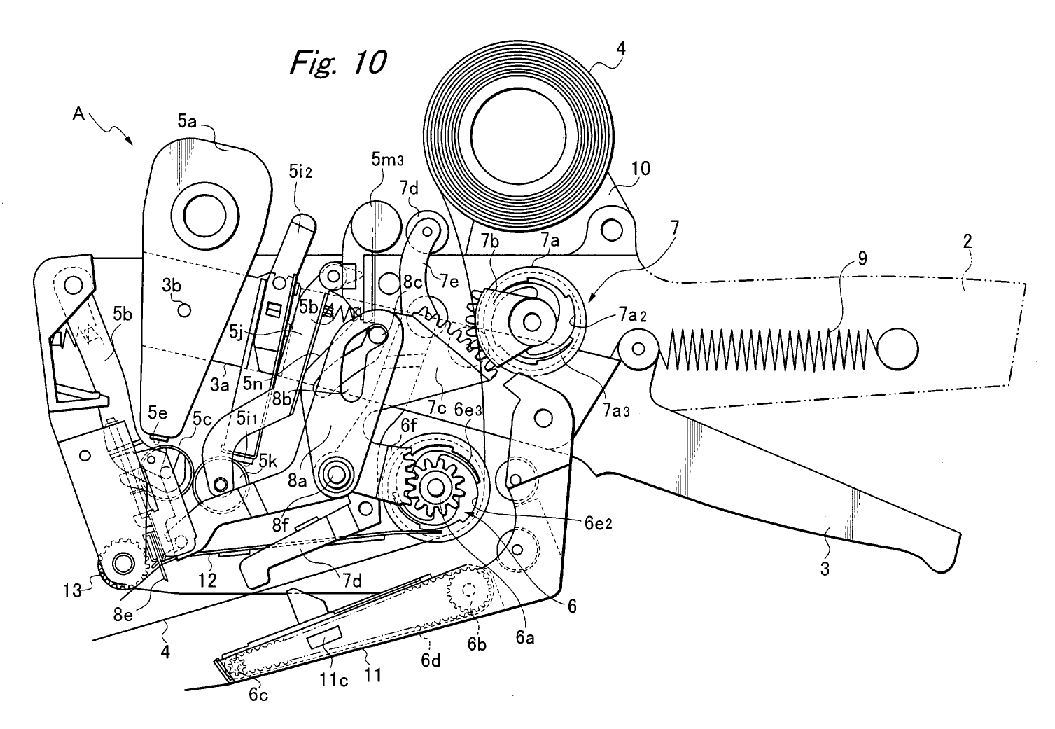

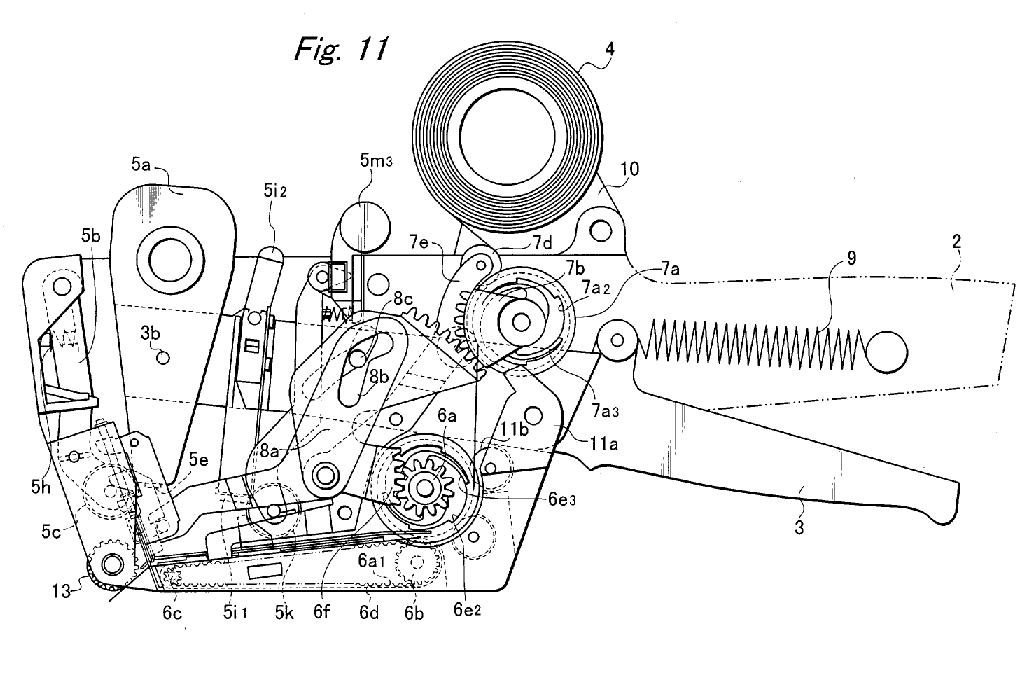

In use, the bottom lid 11 is opened to pull a length of tape 4 to appear ahead of the bottom lid 11, and then, the bottom lid 11 is closed (see FIG. 10). Then, the movable handle 3 of the hand labeler A is moved one third of the way to the stationary grip 2, making the first and second printing heads 5e and 5i₁ to be applied to the first and second inkpads 5c and 5k (see FIG. 11).

The movable handle 3 is moved further to reach one half of the way to the stationary grip 2, making the first printing unit 5a descend, and then, the inkpad holder 5c moves away to make the way for the descending printing head 5e, and at the same time, the ganging links 8a turns about its pivot 8f to raise the cutter blade 8e.

On the other hand, the movable curved plate 7c responds to movement of the cam axle 8c in the cam slot 7c₁ to make the toothed section 7c₂ rotate the counter toothed sector 7b, and hence the ratchet nailed wheel rotates the peeling-off drum 7a counterclockwise. Thus, the length of tape 4 is peeled off from the tape roll against its adhesive power.

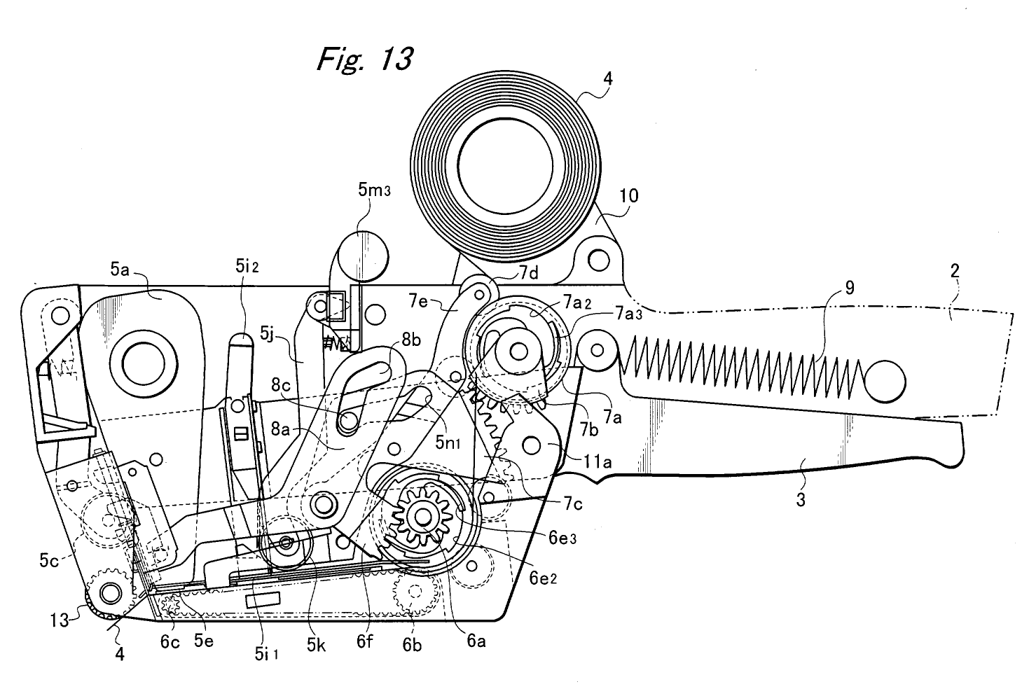

The movable handle 3 is squeezed to reach the stationary grip 2, allowing the ratchet nailed wheel 6e to rotate freely. At the same time, the rotary printing face 5d is lowered until the length of tape 4 is printed (see FIG. 13).

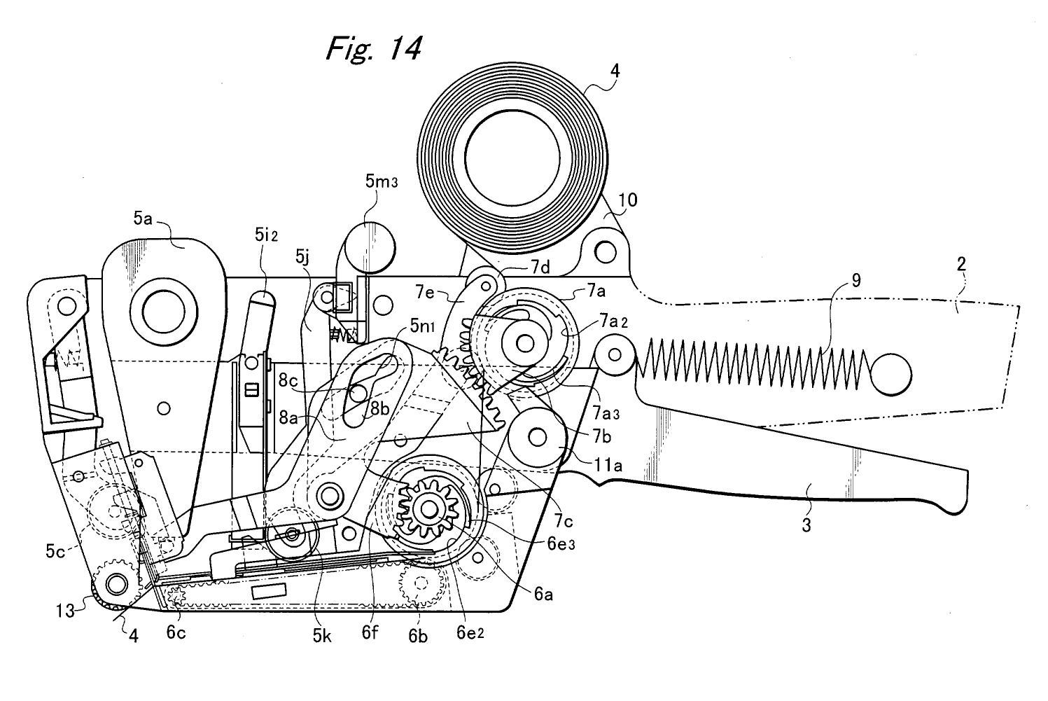

The movable handle 3 is released to travel one half of the way to the initial position, making the ratchet nailed wheel 6e₃ turn clockwise. Thus, the ratchet toothed wheel 6e₂ and hence the rotary drum 6e turn clockwise, thereby making the length of tape advances the predetermined distance equal to the label size (see FIG. 14).

Return of the handle 3 to the initial position causes the ganging links 8a to rise, pushing the cutter blade 8e down to cut and separate the printed length from the tape 4. Thus, the separate printed part or label can be applied to a selected object.

While the movable handle 3 is released (or opened) to return to its initial position, the ratchet nailed wheel 7a₃ is allowed to rotate freely without being caught by any detents of the ratchet toothed wheel 7a₂, so that the tape roll may not be unrolled.

A length of tape having adhesive applied to its rear side is used in the hand labeler as described above. Adhesive tapes whose rear sides are coated with dry thermoplastic agent, or micro-capsulated adhesive or water-, plasticizer- or solvent-and-adhesive mixture may be equally used to meet occasional demands.

What is claimed is:

1. A hand labeler comprising: a seal printing mechanism operatively connected to a handle of the labeler for printing a length of tape via a link mechanism, which can be put in operation by squeezing the handle of the labeler; a tape-feeding mechanism having a rotary drum for making the length of tape advance a predetermined length; and a cutting mechanism responsive to the return of the handle to its release position for cutting the length of tape, characterized in that it further comprises a tape peeling-off mechanism for forcedly feeding the length of tape against its adhesive power, which mechanism is placed between the tape holder section and the rotary drum of the tape-feeding mechanism, and comprises a peeling-off drum ganged with the rotary drum and a tape-feeding roll or rolls freely rotatable to cooperate with the circumference of the peeling-off drum for gripping the length of tape.

2. A hand labeler according to claim 1, wherein it further comprises a ratchet mechanism comprising a ratchet toothed-wheel and associated ratchet nailed wheel for allowing the peeling-off drum to rotate a predetermined angle intermittently, thereby feeding the length of tape step by step.

3. A hand labeler according to claim 1 or 2, wherein the length of tape has no liner on its rear side, which the rear side is coated with adhesive.
